(19) United States
(12) Patent Application Publication
(10) Pub. No.: US 2021/0356598 A1
(43) Pub. Date: Nov. 18, 2021

(54) CAMERA SYSTEM

(71) Applicant: Analog Devices International Unlimited Company, Limerick (IE)

(72) Inventor: Jonathan Ephraim David HURWITZ, Edinburgh (GB)

(73) Assignee: Analog Devices International Unlimited Company, Limerick (IE)

(21) Appl. No.: 17/319,876

(22) Filed: May 13, 2021

Related U.S. Application Data
(60) Provisional application No. 63/025,396, filed on May 15, 2020.

(51) Int. Cl. G01S 17/894; G01S 7/4861; G01S 7/487

(52) U.S. Cl. CPC G01S 17/894; G01S 7/4873; G01S 7/4861

(57) ABSTRACT

Systems and method for a camera system that includes an imaging sensor having differential type imaging pixels. The camera system is configured to read two, single ended signals from each differential pixel, rather than one differential signal. The camera system can be configured to process those single ended signals in one or more different ways in order to determine different types of image and/or to achieve particular desired performance, such as higher speed, more accurate imaging, higher dynamic range imaging, lower noise imaging, etc.

### PRIORITY DATA

This application claims the benefit pursuant to 35 U.S.C § 119(e) of U.S. Provisional Patent Application Ser. No. 63/025,396 filed on May 15, 2020, entitled “TIME OF FLIGHT SYSTEM”, the entirety of which is incorporated by reference herein.

### BACKGROUND

Time-of-flight (ToF) camera systems are range imaging systems that resolve the distance between the camera and an object by measuring the round trip of light emitted from the ToF camera system. The systems typically comprise a light source (such as a laser or LED), a light source driver to control the emission of light from the light source, an image sensor to image light reflected by the subject, an image sensor driver to control the operation of the image sensor, optics to shape the light emitted from the light source and to focus light reflected by the object onto the image sensor, and a computation unit configured to determine the distance to the object based on the emitted light and the corresponding light reflection from the object.

In a Continuous Wave (CW) ToF camera system, multiple periods of a continuous light wave are emitted from the laser. The system is then configured to determine the distance to the imaged object based on a phase difference between the emitted light and the received reflected light. CW ToF systems often modulate the emitted laser light with a first modulation signal and determine a first phase difference between the emitted light and reflected light, before modulating the emitted laser light with a second modulation signal and determine a further phase difference between the emitted light and reflected light. A depth map/depth frame (sometimes referred to as a 3D image) can then be determined based on the first and second phase differences. The first modulation signal and second modulation signals have different frequencies so that the first and second phase differences can be used to resolve phase wrapping. An active brightness frame/2D IR frame (sometimes referred to as a 2D image) can be determined based on the magnitudes of accumulated charge in the imaging pixels of the image sensor.

In a pulsed ToF camera system, one or more pulses of laser light are emitted, with reflected light being received at the image sensor. A depth map/depth frame may be determined based on a time difference between emission of the pulse(s) and reception of the reflected light. An active brightness frame/2D IR frame (sometimes referred to as a 2D image) can be determined based on the magnitudes of accumulated charge in the imaging pixels of the image sensor.

### SUMMARY OF THE DISCLOSURE

Disclosed herein is a camera system that includes an imaging sensor having differential type imaging pixels. The camera system is configured to read two, single ended signals from each differential pixel, rather than one differential signal. The camera system can be configured to process those single ended signals in one or more different ways in order to determine different types of image and/or to achieve particular desired performance, such as higher speed, more accurate imaging, higher dynamic range imaging, lower noise imaging, etc.

In a first aspect of the disclosure there is provided a time of flight, ToF, camera system comprising: an image sensor comprising a plurality of differential imaging pixels; and an image acquisition system coupled to the image sensor and configured to: readout the plurality of imaging pixels by reading out a first single ended signal and a second single ended signal from each of the one or more imaging pixels; for each of at least some of the one or more imaging pixels, determine pixel data based on the first single ended signal and the second single ended signal, wherein the pixel data comprises a difference value indicative of a difference between a first single ended signal and the second single ended signal; and output the pixel data to a processor for the determination of a ToF image frame.

The pixel data may comprise a confidence value indicative of a relative confidence in the difference value.

The confidence value may be determined by at least one of the following: comparing the first single ended signal against a first predetermined confidence threshold; comparing the second single ended signal against a second predetermined confidence threshold; comparing a sum of the first and second single ended signals against a third predetermined confidence threshold; comparing the first single ended signal against a first single ended signal readout from an adjacent imaging pixel; comparing the second single ended signal against a second single ended signal readout from an adjacent imaging pixel; comparing the sum of the first and second single ended signals against a sum of first and second single ended signals readout from an adjacent imaging pixel.

The first predetermined confidence threshold may comprise one or more of: a saturation level of the imaging pixels; and a dark level of the imaging pixels; and wherein the second predetermined confidence threshold comprises one or more of: the saturation level of the imaging pixels; and the dark level of the imaging pixels.

Comparing the first single ended signal against the first single ended signal readout from the adjacent imaging pixel may comprise: determining a difference between the between the first single ended signal against the first single ended signal readout from the adjacent imaging pixel; and comparing the determined difference to a fourth predetermined confidence threshold, wherein if the determined difference is greater than the fourth predetermined confidence threshold, the confidence value is set to indicate a relatively low level of confidence.

The pixel data may comprise a compression flag, and wherein determining the pixel data comprises: determining whether the difference between the first single ended signal and the second single ended signal can be compressed, and if it can be compressed, setting the difference value as a compressed version of the difference between the first single ended signal and the second single ended signal; and setting the compression flag to indicate whether or not the difference value is a compressed value.

Determining whether the difference between the first single ended signal and the second single ended signal can be compressed may comprise one or more of the following: comparing the difference between the first single ended signal and the second single ended signal to a predetermined size threshold, wherein if it is less than the predetermined size threshold it can be compressed; identifying a region of the imaging sensor where a sum of the first single ended signal and the second single ended signal readout from each imaging pixel within the region is similar to within a similarity threshold, the difference between the first single ended signal and the second single ended signal readout from the imaging pixels within the region can be compressed.

The processor may be configured to determine a ToF image based on the pixel data received from the image acquisition system.

The ToF camera system may be a continuous wave ToF camera system.

The image acquisition system may comprise first readout circuitry for reading out the first single ended signal and second readout circuitry for reading out the second single ended signal.

The time of flight, ToF, camera system may be further configured to correct an offset between the first single ended signal and the second single ended signal caused by mismatch of the first readout circuitry and the second readout circuitry.

The image sensor may comprise at least one row of blank pixels configured such that incident light on the image sensor does not result in charge accumulation in the blank pixels, and wherein correcting the offset between the first single ended signal and the second single ended signal for a particular imaging pixel comprises: determining a difference between a first single ended signal of a blank pixel that is in the same pixel column as the particular imaging pixel and a second single ended signal of the blank pixel that is in the same pixel column as the particular imaging pixel; and correcting the offset between the first single ended signal and the second single ended signal for the particular imaging pixel using the determined difference.

The time of flight, ToF, camera system may be further configured to correct an offset and gain error between the first single ended signal and the second single ended signal caused by mismatch of the first readout circuitry and the second readout circuitry, wherein correcting the offset between the first single ended signal and the second single ended signal for a particular imaging pixel comprises: reading out a first pair of single ended signals from a first pixel that is in the same pixel column as the particular imaging pixel, wherein the accumulation values at the first pixel are a first known value; reading out a second pair of single ended signals from a second pixel that is in the same pixel column as the particular imaging pixel, wherein the accumulation values at the second pixel are a second known value; and determining the offset and gain error based on the first pair of single ended signals and the second pair of single ended signals.

The first known value may be a first reference value applied to the first pixel, and wherein the second known value is a second reference value applied to the second pixel.

The first known value may be a first reference value applied to the first pixel, and wherein the second pixel is blank pixel configured such that incident light on the image sensor does not result in charge accumulation in the second pixel.

In a second aspect of the disclosure there is provided a method for determining a ToF image frame, the method comprising: an image sensor comprising a plurality of differential imaging pixels; and an image acquisition system coupled to the image sensor and configured to: reading out charge from a plurality of differential imaging pixels of an image sensor, wherein the charge from each differential imaging pixel is readout as a first single ended signal from a first side of the differential imaging pixel and a second single ended signal from a second side of the differential imaging pixel; determining, for each of the plurality of imaging pixels, a difference between the first single ended signal and the second single ended signal; and determining the ToF image frame using the determined difference between the first single ended signal and the second single ended signal for the plurality of imaging pixels.

In a third aspect of the present disclosure, there is provided a camera system comprising: an image sensor for receiving light reflected by an objected being imaged, wherein the image sensor comprises a plurality of differential imaging pixels; and an image acquisition system coupled to the imaging sensor and configured to: control charge accumulation timing of the plurality of differential imaging pixels such that a first side of the imaging pixels accumulates charge for a first period of time and a second side of the imaging pixels accumulates charge for a second period of time, wherein the first period of time is longer than the second period of time; and readout from each of the plurality of differential pixels a first single ended signal indicative of a charge accumulated by the first side of the imaging pixel and a second single ended signal indicative of a charge accumulated by the second side of the imaging pixel.

The system may be further configured to determine an image using the signals readout from the imaging sensor, wherein determining the image comprises: for each of the plurality of differential pixels, determining from the first single ended signal whether or not the first side of the imaging pixel is saturated, and if the first side of the imaging pixel is determined not to be saturated, use the first single ended signal for the determination of the image, otherwise if the first side of the imaging pixel is determined to be saturated, use the second single ended signal for the determination of the image.

Determining whether or not the first side of the imaging pixel is saturated may comprise comparing the first single ended signal to a saturation threshold.

The system may be further configured to determine an image using for each pixel of the image a weighted combination of the first single ended signal and the second single ended signal, wherein the system is further configured to determine a size of weighting applied to the first single ended signal and a size of the weighting applied to the second single ended signal based on how close the first single ended signal is to saturation.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

To provide a more complete understanding of the present disclosure and features and advantages thereof, reference is made to the following description, taken in conjunction with the accompanying figures, wherein like reference numerals represent like parts, in which:

FIG. 1 shows an example representation of a CW ToF camera system;

FIG. 2 shows an example schematic diagram to help explain an operation of the system of FIG. 1;

FIG. 3 shows example details of a simplified single ended pixel model for a CMOS image sensor;

FIG. 4 shows example details of a simplified differential pixel model for a CMOS image sensor;

FIG. 5 shows a further example camera system;

FIG. 6 shows example details of a simplified differential pixel model for a CMOS image sensor in combination with part of the image acquisition system of the camera system of FIG. 5;

FIG. 7 shows an example representation of accumulated pixel energy for different phases of reflected light relative to transmitted laser light;

FIG. 8A shows a timing diagram visualising reflected light relative to pixel accumulation timing;

FIG. 8B shows a visualisation of two ways in which the relative amount of charge accumulated on sides A and B of a differential pixel may be used to determine a depth frame and/or 2D IR frame

FIGS. 9A and 9B show representations of part of the image acquisition system of the camera system of FIG. 5;

FIG. 10A shows a representation of dynamic range challenges;

FIG. 10B shows an example representation of pixel accumulation timing according to the 2D IR HDR mode of operation;

FIG. 11 shows an example representation of pixel accumulation timing according to the low noise 2D mode of operation;

FIG. 12 shows an example configuration of the image acquisition system for the high speed 2D mode of operation;

FIG. 13 shows a further example configuration of the image acquisition system for the high speed 2D mode of operation; and

FIG. 14 shows the example steps of a process performed by a camera system in accordance with the present disclosure.

### DETAILED DESCRIPTION

In this disclosure, there is a camera system that includes an imaging sensor having differential type imaging pixels. However, rather than reading off each imaging pixel as a differential signal, the camera system is configured to read two, single ended signals from each differential pixel. This enhances the options for how the pixel imaging data may be processed, which results in more options for processing of the signals and enables the camera system to be configured for operation in one or more different modes that achieve particular desired characteristics. For example, some described modes of operation include: compression of signals readout from the imaging sensor; determination of confidence in the signals readout from the imaging sensor; higher dynamic range imaging; faster readout speeds; lower noise imaging; and offset/gain error correction. As a result, the camera system may operate according to desired performance characteristics and may optionally be configured switchably to operate in more than one mode of operation, which enhances flexibility and reconfigurablility of the system.

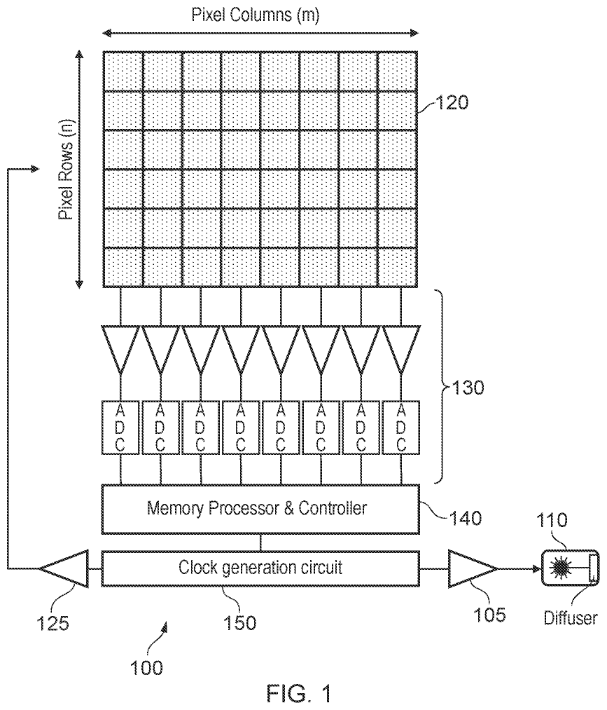

FIG. 1 shows an example representation of a CW ToF camera system 100. The system 100 comprises a laser 110 (which may be any suitable type of laser, for example a VCSEL) and a laser driver 105 configured to drive the laser 110 into light emission.

The system 100 also comprises an imaging sensor 120 that comprises a plurality (in this case m×n) of imaging pixels. A converter system 130 (comprising a plurality of amplifiers and ADCs) is coupled to the imaging sensor 120 for reading off charge accumulated on the imaging pixels and converting to digital values, which are output to the memory processor & controller 140. The memory processor & controller 140 is configured to determine depth frames (also referred to as depth maps), indicative of distance to the object being imaged, based on the received digital values indicative of charge accumulated on the imaging pixels. The memory processor & controller 140 may also be configured to determine active brightness frames (also referred to as 2D IR frames/images). The memory processor & controller 140 controls a clock generation circuit 150, which outputs timing signals for driving the laser 110 and for reading charge off the imaging sensor 120. The converter system 130, memory processor & controller 140 and clock generation circuit 150 may together be referred to as an image acquisition system, configured to determine one or more depth frames by controlling the laser 110 emission, controlling the image sensor charge accumulation timing, reading off the image sensor 120 and processing the resultant data.

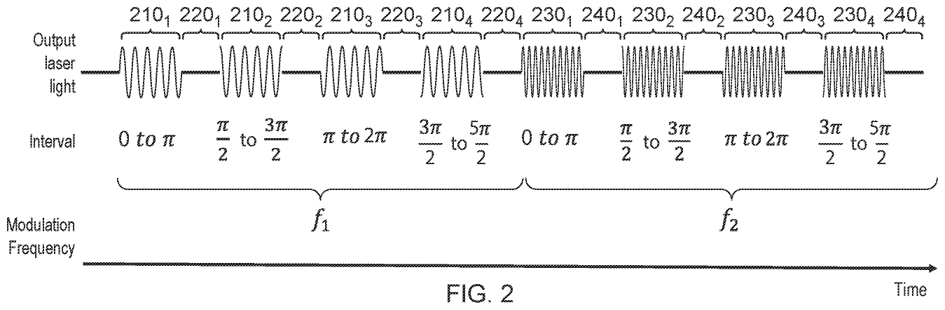

FIG. 2 shows an example schematic diagram to help explain the operation of the system 100. The memory processor & controller 140 and clock generation circuit 150 control the laser 110 to output first laser light modulated by a first modulation signal having a first frequency f₁ for an accumulation period of time 210₁. During this period of time, some of the first laser light reflected from the object will be incident on the imaging sensor 120. During the accumulation period of time 210₁, the memory processor & controller 140 and clock generation circuit 150 also controls the imaging sensor 120 to accumulate charge based on the incident reflected first laser light for the first part/interval of the period/cycle of the first laser light (00 to 180°, or 0 to π). For example, the imaging sensor 120 is controlled to “open its shutter” for charge accumulation at the times when the phase of the emitted first laser light is between 0° to 180°. This is so that the phase of the received first laser light relative to the emitted first laser light at a first interval of 0 to n may later be determined using the charge accumulated on the imaging sensor 120, for example by cross correlating the accumulated charge signal with the first modulation signal. In this example, accumulation takes place for half of the period/cycle of the first laser light, but may alternatively take place for any other suitable amount of time, for example for one quarter of the phase of the first laser light. The skilled person will readily understand how to control the accumulation timing of the imaging sensor 120 using control signals based on the timing of the laser modulation signal. As will be understood by the skilled person, if the image sensor 120 is a single ended pixel type, the pixels may be controlled to accumulate charge for this part/interval of the period and not accumulate any charge for the remainder of the period. If the image sensor 120 is a differential pixel type, the pixels may be controlled to accumulate charge for this part/interval of the period on one side of the pixel and accumulate charge on the other side of the pixel for the remainder of the period. This also applies to the other accumulation parts/intervals described later.

During a subsequent read out period of time 220₁, the memory processor & controller 140 and clock generation circuit 150 control the first laser 110₁ to cease emitting light and control readout image sensor values that are indicative of the charge accumulated in the imaging pixels of the imaging sensor 120. The nature of the readout values will depend on the technology of the imaging sensor 120. For example, if the imaging sensor is a CMOS sensor, voltage values may be readout, where each voltage value is dependent on the charge accumulated in an imaging pixel of the imaging sensor 120, such that the readout values are each indicative of charge accumulated in imaging pixels of the imaging sensor 120. In other sensor technologies, the nature of the readout values may be different, for example charge may be directly readout, or current, etc. For example, the imaging sensor 120 may be controlled to readout image sensor values from row-by-row using any standard readout process and circuitry well understood by the skilled person. In this way, a sample of charge accumulated by each imaging pixel during the period 210₁ may be read off the imaging sensor 120, converted to a digital value and then stored by the memory processor & controller 140. The group of values, or data points, arrived at the conclusion of this process is referred to in this disclosure as a charge sample.

It will be appreciated that the accumulation period of time 210₁ may last for multiple periods/cycles of the first modulation signal (as can be seen in FIG. 1) in order to accumulate sufficient reflected light to perform an accurate determination of the phase of the received reflected light relative to the first modulation signal, for the interval 0 to π of the first modulation signal.

During accumulation period of time 210₂, the memory processor & controller 140 and clock generation circuit 150 again control the first laser 110₁ to output first laser light modulated by the first modulation signal for an accumulation period of time 210₂. This is very similar to the accumulation period 210₁, except during accumulation period of time 210₂ the memory processor & controller 140 and clock generation circuit 150 controls the imaging sensor 120 to accumulate charge for the second part/interval of the period/cycle of the first modulation signal (90° to 270°, or π/2 to 3π/2). The read out period 220₂ is very similar to period 220₁, except the obtained charge sample relates to a shifted or delayed interval of π/2 to 3π/2 of the first modulation signal.

Accumulation period of time 210₃ is very similar to the period 210₂, except the memory processor & controller 140 and clock generation circuit 150 controls the imaging sensor 120 to accumulate charge for the third part/interval of the period/cycle of the first modulation signal (180° to 360°, or π to 2π). The read out period 220₃ is very similar to period 220₂, except the sampled charge data relates to a shifted or delayed interval of π to 2π of the first modulation signal.

Finally, accumulation period of time 210₄ is very similar to the period 210₃, except the memory processor & controller 140 and clock generation circuit 150 also controls the imaging sensor 120 to accumulate charge based on the incident reflected first laser light for a fourth part/interval of the period/cycle of the first modulation signal (270° to 90°, or 3π/2 to π/2). The read out period 220₄ is very similar to period 220₃, except the charge sample relates to a shifted or delayed interval of 3π/2 to π/2 (or, put another, a shifted or delayed interval of 3π/2 to 5π/2).

It can be seen from the above that for each accumulation period 210₁-210₄, the start timing of pixel accumulation timing relative to the laser modulation signal is shifted (i.e., the relative phase of the laser modulation signal and the pixel demodulation signal, which controls pixel accumulation timing, is shifted). This may be achieved either by adjusting the pixel demodulation signal or by adjusting the laser modulation signal. For example, the timing of the two signals may be set by a clock and for each of the accumulation periods 210₁-210₄, either the laser modulation signal or the pixel demodulation signal may be incrementally delayed by π/2.

Whilst in this example each accumulation period 210₁-210₄ lasts for 50% of the period of the laser modulation signal (i.e., for 180°), in an alternative each accumulation period may be shorter, for example 60°, or 90°, or 120°, etc, with the start of each accumulation period relatively offset by 90° as explained above.

After completing this, four samples of data (charge samples) have been acquired and stored in memory. They together may be referred to as a first set of charge samples. Immediately after the read out period 220₄, or at some later time, a phase relationship between the first laser light and the received reflected light may be determined using the four charge samples (for example by performing a discrete Fourier transform (DFT) on the samples to find the real and imaginary parts of the fundamental frequency, and then determining the phase from the real and imaginary parts, as will be well understood by the skilled person). This may be performed by the image acquisition system, or the charge samples may be output from the image acquisition system to an external processor via a data bus for the determination of the phase relationship. Optionally, active brightness (2D IR) may also be determined (either by the image acquisition system or the external processor) for the reflected first laser light using the four samples (for example, by determining the magnitude of the fundamental frequency from the real and imaginary parts, as will be well understood by the skilled person).

Whilst in this example four samples of data are obtained by having four accumulation periods 210₁-210₄, for some types of imaging pixel the same number of samples may be obtained from fewer accumulation periods. For example, if the imaging pixels are differential pixels, or two tap pixels, one half of each pixel may be readout for the sample relating to accumulation interval 0° to 180°, and the other half may be readout for accumulation interval 180° to 360°. Therefore, two samples may be obtained from a single accumulation period 210₁ and readout 220₁. Likewise, two samples for 90° to 270° and 270° to 450° may be obtained from a single accumulation period 210₂ and readout 220₂. In a further example, if four tap imaging pixels are used with the start of accumulation on each relatively offset by 90°, all four samples may be obtained from a single accumulation period and readout. However, even when two or more samples may be obtained for two or more different phase off-sets in a single accumulation period and readout, optionally multiple accumulation periods and readouts may still be performed, with each phase offset being moved around the available accumulation region of each imaging pixel for each successive accumulation periods, in order to correct for pixel imperfections. For example, for a four tap imaging pixel, there may be four accumulation periods and readouts with the phase offsets being successively moved around the four accumulation regions of each pixel, resulting in four samples for each phase offset, each sample being readout from a different accumulation region of the pixel, meaning that pixel imperfections can be corrected using the samples.

The skilled person will readily understand that using DFT to determine the phase relationship between the first laser light and the received reflected laser light, and to determine active brightness, is merely one example and that any other suitable alternative technique may be used. By way of brief explanation a further non-limiting example is now described.

The transmitted, modulated laser signal may be described by the following equation:

s(t)=Aₛ sin(2πft)+Bₛ

### Where:

s(t)=optical power of emitted signal
f=laser modulation frequency
Aₛ=amplitude of the modulated emitted signal
Bₛ=offset of the modulated emitted signal

The signal received at the imaging sensor may be described by the following equation:

$$r ( t ) = α ( {A}_{s} sin ( 2 π ft + Φ ) + {B}_{s} ) + {B}_{env}$$

$$Φ = 2 π f Δ$$

$$Δ = \frac{2 d}{c}$$

### Where:

r(t)=optical power of received signal
α=attenuation factor of the received signal
Φ=phase shift
Bₑₙᵥ=amplitude of background light
Δ=time delay between emitted and received signals (i.e., time of flight)
d=distance to imaged object
c=speed of light

Accumulation timing of the imaging pixels may be controlled using a demodulation signal, g(t−τ), which is effectively a time delayed version of the illumination signal.

g(t−τ)=A_{g} sin(2πf(t−τ))+B_{g}

### Where:

τ=a variable delay, which can be set to achieve the phase delays/offsets between each accumulation period 210₁-210₄ described above
A_{g}=amplitude of the demodulation signal
B_{g}=offset of the demodulation signal

The imaging pixels of the imaging sensor effectively multiply the signals r(t) and g(t−τ). The resulting signal may be integrated by the imaging pixels of the imaging sensor to yield a cross correlation signal c(τ):

c(τ)=A sin(2πf(t−τ))+B

By driving the imaging sensor to accumulate at different offsets during different accumulation periods, as described above, it is possible to measure correlation at different time offsets τ (phase-offsets φ) 0, π/2, π, 3π/2:

$$c ( τ ) = A sin ( 2 π f ( t - τ ) ) + B = A sin ( Φ - φ ) + B$$

$$c ( τ ) = A ( sin ( Φ ) cos ( - φ ) + cos ( Φ ) sin ( - φ ) ) + B$$

$$c ( 0 ) = A 1 = A ( sin ( Φ ) ) + B$$

$$c ( \frac{π}{2} ) = A 2 = - A ( cos ( Φ ) ) + B$$

$$c ( π ) = A 3 = - A ( sin ( Φ ) ) + B$$

$$c ( \frac{3 π}{2} ) = A 4 = A ( cos ( Φ ) ) + B$$

From these readings, it can be determined that the phase offset/time of flight can be found by:

$$Φ = 2 π f Δ = arctan ( \frac{sin ( Φ )}{cos ( Φ )} ) = atan ( \frac{A 1 - A 3}{A 4 - A 2} )$$

Therefore, a depth image or map can be determined using the four charge samples acquired from the image sensor.

An active brightness, or 2D IR, image/frame may also be determined by determining \sqrt{(A4−A2)²+(A1−A3)²}.

Subsequently, the process described earlier in relation to periods 210₁-210₄ and 220₁-220₄ may then be repeated in accumulation periods 230₁-230₄ and read out periods 240₁-240₄. These are the same as the accumulation periods 210₁-210₄ and read out periods 220₁-220₄, except rather than driving the laser 110₁ to emit light modulated with the first modulation signal, the laser 110 is driven to emit light modulated with a second modulation signal. The second modulation signal has a second frequency f₂, which is higher than the first frequency f₁. As a result, four further samples of data (charge samples) are obtained and stored in memory. Based on these charge samples, a phase relationship between the second laser light and the received reflected light (and optionally also the active brightness for the reflected second laser light) may be determined either by the image acquisition system or the external processor, for example using DFT or correlation function processes as described above.

Using the determined phase relationship between the first laser light and the received reflected light and the determined phase relationship between the second laser light and the received reflected light, phase unwrapping may be performed and a single depth image/frame determined by the memory processor & controller 140 (as will be understood by the skilled person). In this way, any phase wrapping issues can be resolved so that an accurate depth frame can be determined. This process may be repeated many times in order to generate a time series of depth frames, which may together form a video.

Optionally, a 2D IR frame may also be determined using the determined active brightness for the first laser light and/or the determined active brightness for the second laser light.

A pulsed ToF camera system shall not be described in detail herein. The skilled person will readily understand that a pulsed ToF camera system may be very similar to the system 100, but with the image acquisition components 130, 140 and 150 reconfigured to control pulsed emission from the laser 110 and determine a depth frame based on a time difference between emission of a pulse and reception of reflected light. A 2D IR frame may also be determined based on the magnitude of charge accumulated in the imaging pixels of the image sensor 120.

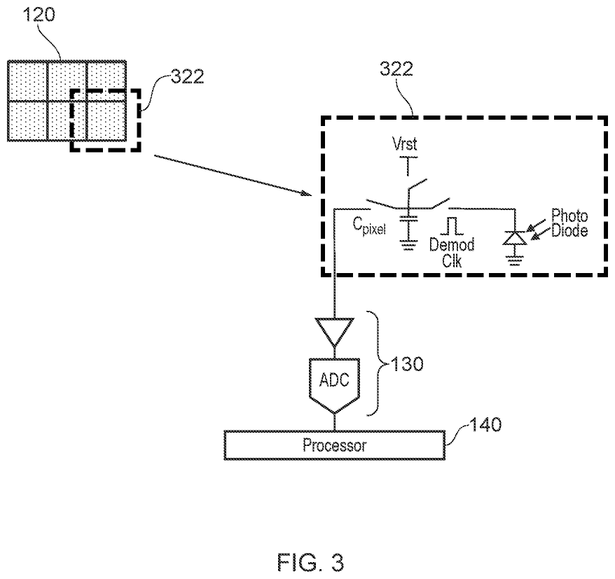

In FIG. 1, the image sensor 120 is a single-ended pixel readout design, such that during readout, one single ended signal is read out from each imaging pixel. FIG. 3 shows example details of a simplified single ended pixel model for a CMOS image sensor. An example configuration of one imaging pixel 322 is represented in the FIG. Rows and columns of the imaging sensor 120 are addressable and typically the camera system 100 may have an amplifier and ADC per column, with pixel charges being readout row by row. Correlated double sampling may be performed to minimise kTC noise.

However, image sensors may alternatively have a differential pixel readout design, such that during readout, a differential signal is readout from each imaging pixel.

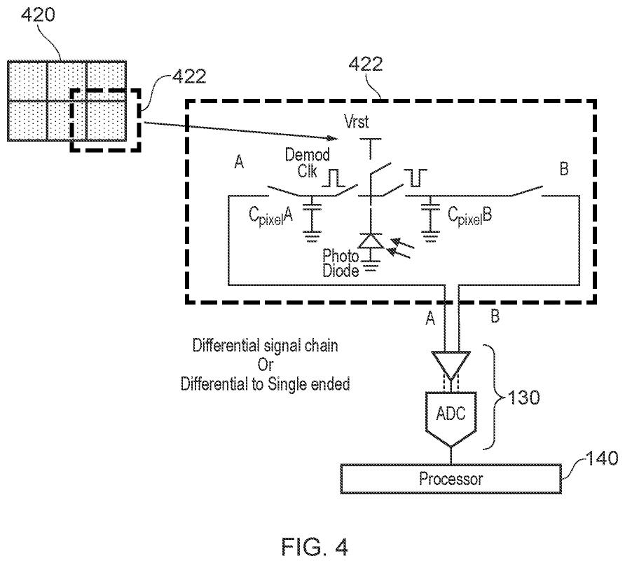

FIG. 4 shows example details of a simplified differential pixel model for a CMOS image sensor 420. An example configuration of one imaging pixel 422 is represented in the FIG. In this example, the amplifiers that are part of the readout circuitry 130 are differential amplifiers. Again, rows and columns of the imaging sensor 120 are addressable and typically the camera system 100 may have an amplifier and ADC per column, with pixel charges being readout row by row. For a CW ToF camera system, side A and side B may be operated in anti-phase, such that when CₚᵢₓₑₗA is accumulating charge, CₚᵢₓₑₗB is not, and vice-versa. The differential pixels 422 may accumulate charges on alternate sides A and B. For example CₚᵢₓₑₗA may accumulate charge during the interval 0 to π and CₚᵢₓₑₗB may accumulate charge during the interval π to 0 during the accumulation periods 210₁ and 230₁. CₚᵢₓₑₗA may accumulate charge during the interval

$$\frac{π}{2} to \frac{3 π}{2}$$

and Cₚᵢₓₑₗ B may accumulate charge during the interval

$$\frac{3 π}{2} to \frac{π}{2}$$

during accumulation periods 210₂ and 230₂, etc. The accumulated charges may be readout during the readout periods 220₁-220₄ and 240₁-240₄ as differential voltages, amplified by the differential amplifiers and digitally converted by the ADCs before onward processing by the memory, processor and controller 140. Correlated Double Sampling (CDS) measurements may be conducted to minimise kTC noise contribution from the reset voltage Vrst (reference voltage). Samples of the reset voltage and corresponding pixel voltages may be stored on an analog storage device, such as one at the amplifier, and then subtracted from the readout pixel charge signal prior to digital conversion to achieve CDS subtraction in the analog domain, or samples of the reset voltage may be converted individually and subtracted from the readout pixel charge signal in the digital domain.

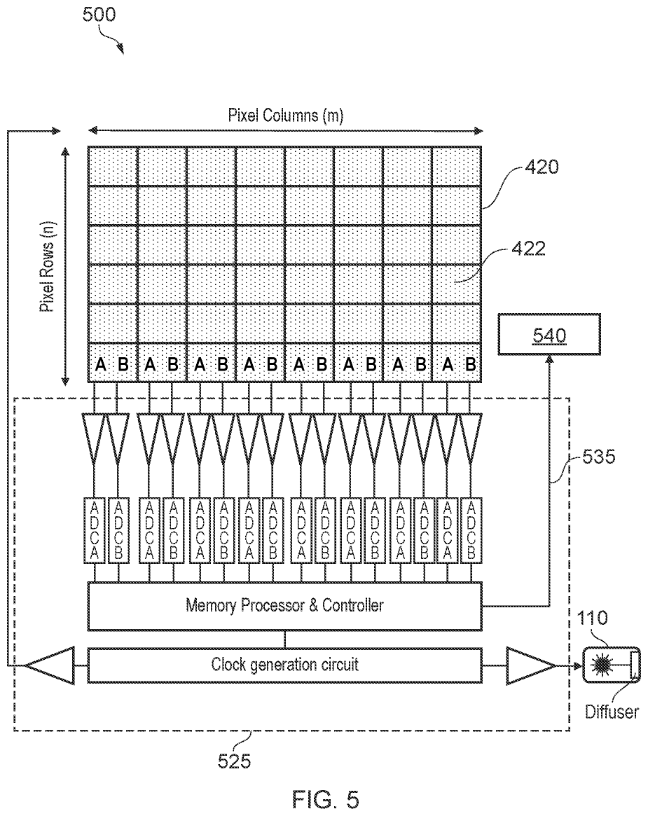

FIG. 5 shows a camera system 500 in accordance with an aspect of the present disclosure. The camera system 500 includes a differential type image sensor 420, but the image acquisition system 525 is configured to read out two single ended signals from each imaging pixel 422. As will be appreciated from the description later, the image acquisition system 525 may be configured in many different ways in order to implement one or more different modes of operation. By way of example only, in FIG. 5 the image acquisition system 525 is shown to have single ended amplifiers and ADCs, a memory, processor & controller, a clock generation circuit, a laser driver and image sensor control signal buffer/amplifier. However, any suitable configuration may be implemented in order to perform one or more of the modes of operation described later. By way of initial example, in FIG. 5 there are two single ended amplifiers or buffers and two ADCs per pixel column. In an alternative, the amplifiers may be omitted entirely, for example if the signal readout from the image sensor 420 is sufficiently large. In a further alternative, one single-ended ADC may be provided per pixel column (optionally with one or two single ended amplifiers), which may be multiplexed to convert both signals A and B. Providing one single ended ADC per column may reduce the size and cost of the image acquisition system 525, but also reduce readout speed.

The digitally converted single ended readouts may be post processed in the digital domain by the memory processor & controller (or any other suitable device) to deliver more information than a single differential readout in order to determine depth frames and/or 2D IR frames according to CW and/or pulsed operation. CDS measurements are conducted to minimise kTC noise contribution from the reset voltage Vrst (reference voltage). Some of the operations described below are also applicable more generally to other types of camera systems, not just ToF system (i.e., camera systems that do not seek to determine a distance/depth to an object, but rather simply to generate an image of a scene, such as just a 2D IR frame).

In this example, the image acquisition system is configured to output, for each imaging pixel that has been readout, pixel data to an application processor 540 via a data bus 535, for the application processor 540 to determine the depth frame and/or 2D IR frame. However, in an alternative the application processor 540 and data bus 535 may be omitted and the image acquisition system 525 (for example, the memory Processor & Controller) configured to determine the depth frame and/or 2D IR frame itself using the generated pixel data.

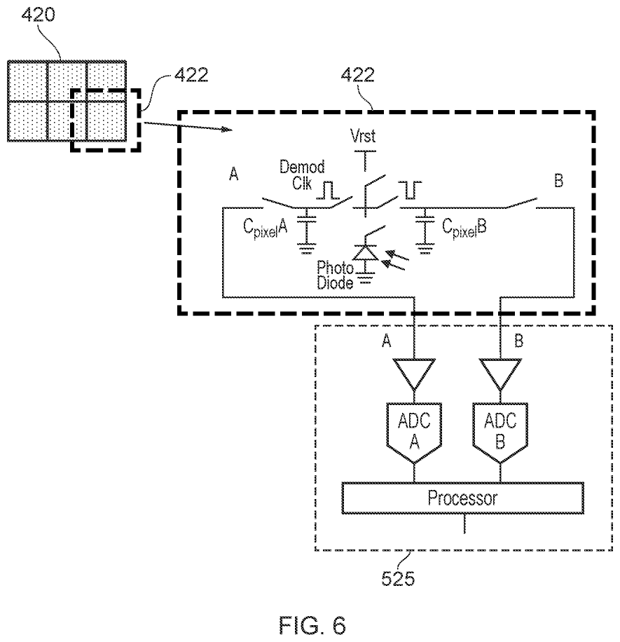

FIG. 6 shows example details of a simplified differential pixel model for the CMOS image sensor 420 in combination with part of the image acquisition system 525.

By reading off the values from a differential pixel as two single ended signal, the reconfigurability of the camera system may be enhanced such that it can operate in a number of different modes of operation to meet different accuracy, speed and image type (for example, depth frame or 2D IR) demands. Additionally, or alternatively, it makes it possible to do additional operations that enhance the accuracy/reliability of the generated image frame and/or reduce the amount of data transfer to an external processor that determines the image frame. These are described later in the sections “compression”, “confidence” and “offset/gain correction”.

The image acquisition system 525 may be configured to operate in one or more of the following modes of operation. For example, it may be configured to operate in only one of the modes of operation and therefore be fixed only to that mode of operation. Alternatively, it may be configured to operate in two or more of the modes of operation, such that the same ToF camera system 500 may switch between different modes of operation as required.

CW 3D Mode

The image acquisition system 525 may be configured to operate as a continuous wave (CW) ToF system for determining a depth frame and/or 2D IR frame. In this mode of operation, the single ended signals A and B are read out and A−B (and optionally also A+B) subsequently determined by the image acquisition system 525 as part of the determination of a depth image and/or 2D IR image.

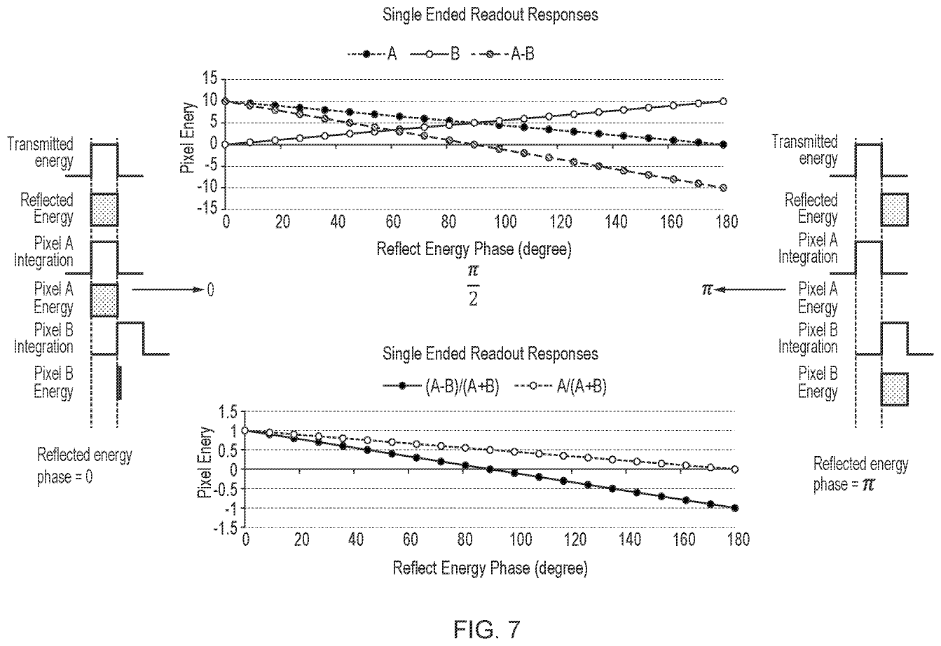

FIG. 7 shows an example representation of accumulated pixel energy for different phases of reflected light relative to transmitted laser light. The timing diagram on the left side shows a visualisation of the phase of the reflected light (reflected energy) relative to the transmitted light (transmitted energy) being 0 (for example, for light reflected off objects that are very close to the camera system). The timing diagram on the right side shows a visualisation of the phase of the reflected light (reflected energy) relative to the transmitted light (transmitted energy) being n, or 180°. The image acquisition system 525 may be configured to control the image sensor 420 to accumulate charge on the ‘A’ side of the imaging pixels during the interval 0 to π of the laser modulation signal (‘Pixel A integration’). This may be done, for example, by using the ‘demod clk’ represented in FIG. 6 to control the imaging pixels 422 to open their shutter on the A side and close their shutter on the B side during the interval 0 to π of the laser modulation signal. The image acquisition system 525 may be configured to control the image sensor 420 to accumulate charge on the ‘B’ side of the imaging pixels during the interval TT to 27T of the laser modulation signal (‘Pixel B integration’). This may be done, for example, by using the ‘demod clk’ represented in FIG. 6 to control the imaging pixels 422 to open their shutter on the B side and close their shutter on the A side during the interval n to 2π of the laser modulation signal. As can be seen on the timing diagram on the left side of FIG. 7, when the reflected light is in phase with the transmitted light, all (or almost all) energy accumulated in the pixel 422 will be on the A side. As can be seen on the timing diagram on the right side of FIG. 7, when the reflected light has a phase of π relative to the transmitted light, all (or almost all) energy accumulated in the pixel 422 will be on the B side.

The upper-central graph shows how accumulated energy in sides A and B changes with changes in the phase of the reflected light relative to the transmitted light. It also shows how A−B changes with phase. The units of pixel energy are arbitrary. As can be seen, the amount by which pixel energy changes with phase of received reflected light is double for A−B compared with A or B alone. This means that by determining A−B, the resolution of the system may be doubled compared with considering A or B alone. The lower-central graph shows normalised accumulated energy for A−B and for A alone (normalization being carried out by dividing by A+B). Again, it can be seen that the amount by which pixel energy changes with phase is double for A−B compared with A (or B) alone.

A depth frame may then be determined by the image acquisition system 525, or a different external system/processor, using the process described above with reference to FIG. 2 for the determined A−B (or normalised A−B). For example, during accumulation period 210₁, charge may be accumulated on the A side for the interval 0 to π and accumulated on the B side for the interval π to 2π. A and B may then be readout during 220₁ and A−B subsequently determined. A−B, or (A−B)/(A+B), then acts as the first charge sample. This may be repeated for each of the accumulation periods 210₂-230₄ and 230₁-230₄ and readout periods 220₂-220₄ and 240₁-240₄, with suitable shifts in the accumulation periods for sides A and B and a change in the frequency of the laser light modulation signal for samples 5-8. Therefore, eight samples of A−B, or (A−B)/(A+B), will be obtained from the image sensor 420 by the image acquisition system 525, based on which a depth frame may be generated, for example using the DFT, phase determination and phase unwrapping processes described earlier with reference to FIG. 2. Additionally, or alternatively, a 2D IR frame may also be determined from A−B, or (A−B)/(A+B), using the DFT and magnitude determination process described earlier with reference to FIG. 2, or simply based on the magnitudes of A, B, A−B or A+B.

By reading off two single ended signals from each pixel 422, rather than a differential signal, each ADC may be smaller than might be required for a differential signal. By way of example, if a digital conversion of A−B were to require 11-bits of resolution, an 11-bit ADC would be needed for each column of pixels. However, since single ended signals A and B each have half the resolution of A−B, a smaller single ended ADC for each of A and B may instead be used, for example 10-bit ADCs. Smaller ADCs typically complete their conversions more quickly, requiring less settling time. CDS may also be achieved more straightforwardly. Thus, digitally converting A and B as single ended signals and then determining the higher resolution A−B in the digital domain may be achieved more quickly and with more straightforward CDS.

Pulsed 3D Mode

The image acquisition system 525 may be configured to operate as a pulsed ToF system for determining a depth frame and/or 2D IR frame. In this mode of operation, the single ended signals A and B are read out and A−B and/or A+B subsequently determined by the image acquisition system 525 as part of the determination of a depth image and/or 2D IR image.

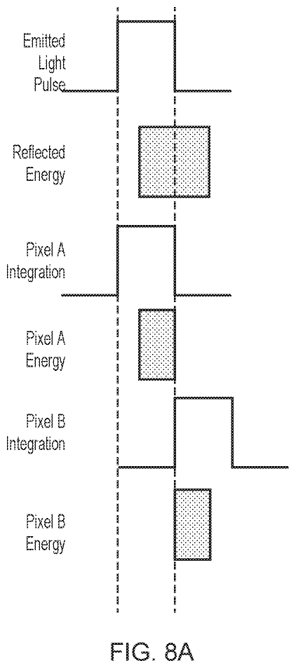

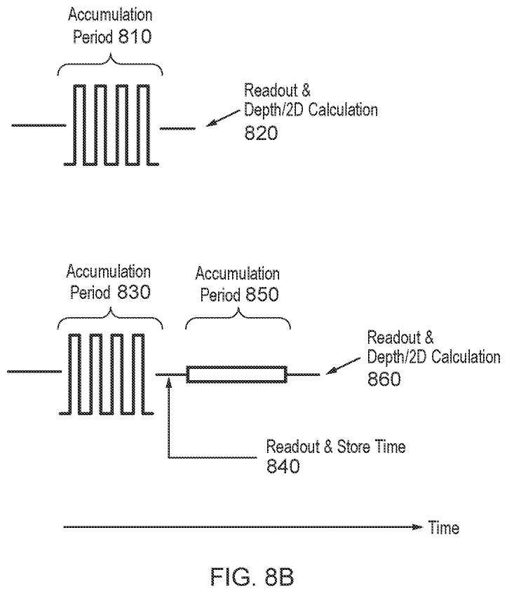

FIGS. 8A and 8B are diagrams to help explain the process of determining a depth frame and/or 2D IR frame. FIG. 8A shows a timing diagram visualising reflected light (‘reflected energy’) relative to a period during which light is accumulated on the ‘A’ side of the imaging pixels 422 (‘Pixel A Integration’) and a period during which light is accumulated on the ‘B’ side of the imaging pixels 422 (‘Pixel B Integration’). This may be done, for example, by using the ‘demod clk’ represented in FIG. 6 to control the imaging pixels 422 to open their shutter on the A side and close their shutter on the B side during the interval 0 to π of the laser modulation signal, and close their shutter on the A side and open their shutter on the B side during the interval π to 2π of the laser modulation signal. As can be seen, the amount of energy accumulated on each of A and B varies depending on when the reflected light is received relative to the emitted pulse of light.

FIG. 8B shows a visualisation of two ways in which the relative amount of charge accumulated on sides A and B may be used to determine a depth frame and/or 2D IR frame. In the first example, it is assumed that there is negligible (or no) ambient light, for example the camera system is operating in the dark, such that most (or all) accumulated charge is caused by reflected laser light. In this case, charge is accumulated on sides A and B of the pixels 422 during the accumulation period 810. In this example, the laser light is pulsed multiple times in order to increase the amount of accumulated charge. However, it may be pulsed once, or any number of times, during this period. Side A of the pixels 422 may accumulate charge for 50% of the duty cycle of the laser modulation signal and side B may accumulate charge for the remaining 50% of the duty cycle. Subsequently, single ended signals A and B are readout from each pixel and a depth frame and/or 2D IR frame determined during period 820. A depth for each pixel may be determined as follows:

$$Depth = \frac{A}{A + B} \times \frac{c}{2 {f}_{mod}}$$

where c=speed of light and f_{mod}=the modulation frequency of the laser light. Thus, a depth frame may be determined from a single accumulation period 810 and readout period 820. In an alternative

$$\frac{A - B}{A + B} \times \frac{c}{2 {f}_{mod}}$$

could also be used to determine depth.

A 2D IR frame may be determined from the magnitude of any of A, or B, or A+B, or (A+B)/2 on the pixels 422. Thus, a 2D IR frame may be determined from a single accumulation period 810 and readout period 820. In the second example, it is assumed that ambient light cannot be ignored. Accumulation period 830 is the same as accumulation period 810 described above. Single ended signals A and B for each pixel 422 may then be readout during period 840 and stored in memory. These are referred to below as A1 and B1. Accumulation period 850 is the same as period 830, except the laser 110 is not driven to emit light. Thus, the charge accumulated during period 850 represents ambient, or background, light (A_{bg} and B_{bg}) and the charge accumulated during period 830 represents ambient light (A_{bg} and B_{bg}) plus reflected laser light (A and B). Single ended signals A and B for each pixel 422 may then be readout during period 860. The single ended signals readout during period 860 are referred to below as A2 and B2.

A depth frame may then be determined based on the following:

$$Depth = \frac{A 1 - A 2}{( A 1 + B 1 ) - ( A 2 + B 2 )} \times \frac{c}{2 {f}_{mod}}$$

$$Depth = \frac{( A + {A}_{bg} ) - {A}_{bg}}{( A + {A}_{bg} + B + {B}_{bg} ) - ( {A}_{bg} + {B}_{bg} )} \times \frac{c}{2 {f}_{mod}}$$

$$Depth = \frac{A}{A + B} \times \frac{c}{2 {f}_{mod}}$$

Thus, a depth frame may be determined from two accumulation periods 830 and 850 and two readout period 840 and 860.

A 2D IR frame may be determined, for example, from any of (A1+B1)−(A2+B2); (A1+B1)/2−(A2+B2)/2; A1-A2; B1-B2, etc. Thus, a 2D IR frame may be determined from two accumulation periods 830 and 850 and two readout periods 840 and 860.

In this example, the illumination period 830 is carried out before the background period 850. However, they may alternatively be performed the other way around.

For both the CW and pulsed 3D modes of operation described above, taking two single ended readouts from each pixel 422 may have a number of benefits.

Offset/Gain Correction

In one example, correction of any inherent mismatch between side A and side B of each pixel 422 may be carried out. Even though a differential pixel is a single pixel such that sides A and B are closely co-located, there may still be inherent mismatch between the two sides as a result of non-idealities in wafer fabrication processing, including geometry limitations and/or inhomogeneous material properties, etc. Similarly, components in the readout circuitry (such as in the amplifiers and/or ADCs) may introduce some offset and/or gain mismatch between sides A and B. For example, transistors in the circuitry, such as those in source followers, may introduce offsets and/or gain errors as a result of not being perfectly matched. A number of different techniques may be used to correct any offset and/or gain error between the readout circuitry used for side A and side B. For example, the image acquisition system 525 may be configured to trim the reference voltage of the ADCs in order to perform analog gain trimming. In this case, the ADCs used for each column may be trimmed in order to correct any offset and/or gain error between side A and side B. In an alternative, flexible gain and/or offset matching per pixel 422 may be carried out by the image acquisition system 525 in the digital domain. The correction is made to the A and/or B signal prior to determining A−B. Therefore, the ability to correct offset and/or gain is achieved by virtue of reading out two single ended signals from each pixel, rather than one differential signal.

In a further alternative, offset and/or gain error correction/minimisation may be performed by chopping. In this example, the A and B readout channels may be swapped.

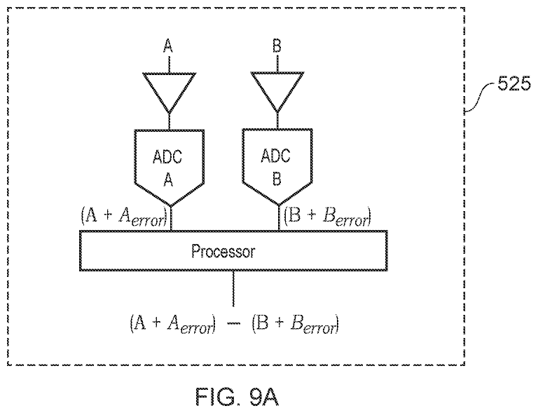

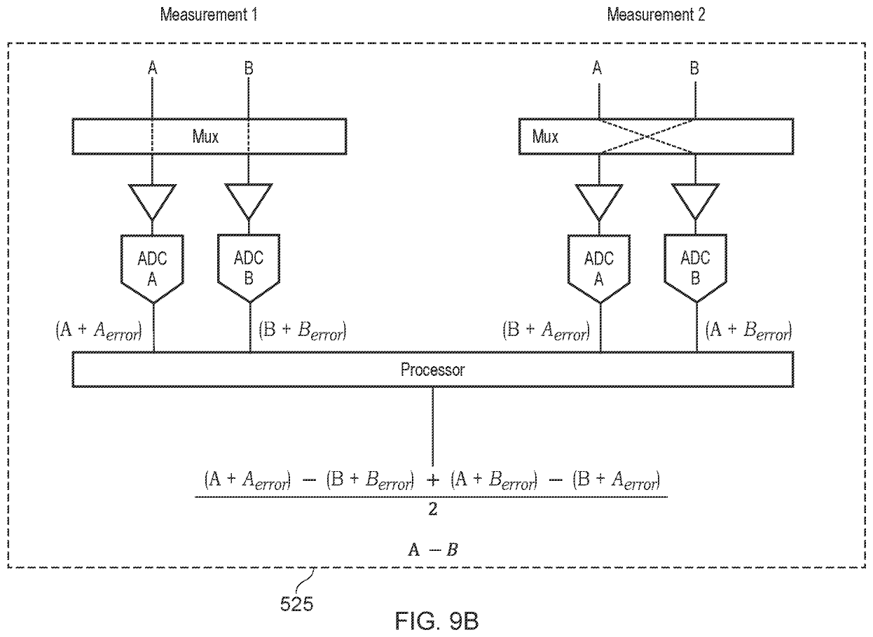

For example, FIG. 9A shows a representation of part of the image acquisition system 525 to demonstrate offset between the readout circuitry on side A and side B. In this case, the amplifiers and ADCs introduce a error caused by offset and/or gain mismatch of Aₑᵣᵣₒᵣ on side A, and Bₑᵣᵣₒᵣ on side B. As a result, it can be seen that the determined difference between the readout charge on side A minus the readout charge on side B is in fact: (A+Aₑᵣᵣₒᵣ)−(B+Bₑᵣᵣₒᵣ).

FIG. 9B shows an example chopping arrangement where the image acquisition system 525 includes a MUX configured to swap the channels A and B between readouts/measurements. In this example, the accumulated charges on side A and side B of the pixel 422 may be readout a first time (measurement 1). The Mux may then swap the channels and the accumulated charges on side A and side B of the pixel 422 may be readout a second time (measurement 2). The average of A−B for the two measurements may then be found, as follows:

$$\frac{( A + {A}_{error} ) - ( B + {B}_{error} ) + ( A + {B}_{error} ) - ( B + {A}_{error} )}{2}$$

As a result, the offsets cancel out and a result of A−B is arrived at. In this example, readout time may take twice as long, but offset is corrected and there is a 42 improvement in readout noise.

In a further example benefit of chopping, diagnostics may be performed to determine that the camera system is operating safely (for example, as part of functional safety diagnostics). For example, we may refer to the first measurement of channel A−(A+Aₑᵣᵣₒᵣ)−as Aₘₑₐₛᵤᵣₑₘₑₙₜ₁, and the second measurement of channel A−(A+Bₑᵣᵣₒᵣ)−as Aₘₑₐₛᵤᵣₑₘₑₙₜ₂. Likewise, we may refer to the first measurement of channel B−(B+Bₑᵣᵣₒᵣ)−as Bₘₑₐₛᵤᵣₑₘₑₙₜ₁, and the second measurement of channel B−(B+Aₑᵣᵣₒᵣ)−as Bₘₑₐₛᵤᵣₑₘₑₙₜ₂. We may then assume that if:

A_{measurement 1}−A_{measurement 2}<Safety Threshold

and

B_{measurement 1}−B_{measurement 2}<Safety Threshold

then the measurement channels for that pixel column are functioning correctly and safely. If this condition is not met, it may be assumed that there is a fault in at least part of one of the measurement channels for that pixel column, which may ultimately cause an operational safety problem. The safety threshold may be set at any suitable value, for example in consideration of expected or reasonable offsets and/or gain mismatches between channel A and channel B. Since ToF camera systems may often be used in safety critical applications, such as vehicle driving aids, etc, action may be taken if a fault is detected. This may include flagging the determined depth frames and/or 2D IR frames as potentially unreliable (for example so that other systems may not make use of them), or routing the measurements from the faulty column to other measurement channels available in the image acquisition system 525, etc.

In a further example of chopping when used in a CW-ToF system, rather than taking each readout twice with the channels chopped for each, all of the readouts 220₁-220₄ (described earlier with reference to FIG. 2) may be performed with the Mux in one configuration. As a result of this, when the laser light is modulated with the first modulation frequency, the image acquisition system 525 may determine (A+Aₑᵣᵣₒᵣ)−(B+Bₑᵣᵣₒᵣ) for each of the samples readout at 220₁-220₄. The Mux may then swap the channels in order then to perform the readouts 240₁-240₄. As a result of this, when the laser light is modulated with the second modulation frequency, the image acquisition system 525 determines (A+Bₑᵣᵣₒᵣ)−(B+Aₑᵣᵣₒᵣ) for each of the samples readout at 240₁-240₄. The depth frame and/or 2D IR frame is then effectively determined as a weighted average of the charge samples for both modulation frequencies, such that offset/gain correction is achieved by chopping without having to double the number of readouts.

In a further example of chopping, the Mux may chop the channels for alternate depth frames and/or 2D IR frames, such that the readouts 220₁-220₄ and 240₁-240₄ are all performed with the Mux in one configuration before the Mux swaps the channels for the set of readouts 220₁-220₄ and 240₁-240₄ performed for the next frame. Consequently, there may effectively be frame to frame averaging of the offsets that should cancel out any residual readout offset.

In a further example, offset and/or gain error may be determined by setting pixel accumulation values to known values. For example, a first reference value (such as a known reference voltage or charge) may be applied to a first pixel in the imaging sensor 120. The first reference value may be applied to both sides of the first pixel such that the accumulation value on both sides of the first pixel is Ref₁.

As a result, when the pair of single ended signals, A and B, are read off the first pixel, we arrive at:

A₁=Gain_{A}×Ref₁+Offset_{A}

B₁=Gain_{B}×Ref₁+Offset_{B}

where:
Gain_{A} is the gain applied on the A side readout circuitry
Gain_{B} is the gain applied on the B side readout circuitry
Offset_{A} is the offset on the A side readout circuitry
Offset_{B} is the offset on the B side readout circuitry

A second reference value (such as a known reference voltage or charge) may be applied to a second pixel in the imaging sensor 120, where that second pixel is in the same column as the first pixel and therefore shares the same readout circuitry. The second reference value may be applied to both sides of the second pixel such that the accumulation value on both sides of the second pixel is Ref₂.

As a result, when the pair of single ended signals, A and B, are read off the second pixel, we arrive at:

A₂=Gain_{A}×Ref₂+Offset_{A}

B₂=Gain_{B}×Ref₂+Offset_{B}

Since A₁, A₂, B₁, B₂, Ref₁ and Ref₂ are all known, the gain and offset values can be found. As a result, gain and/or offset for the readout circuitry of a particular pixel column can be corrected, thereby improving the accuracy of the readout signals A and B and, therefore, by extension improving the accuracy of any determined depth frame or 2D IR frame.

In an alternative, one of the two pixels may be a blanked/blocked pixel which has been coated to prevent light from reaching the charge accumulation part of the pixel. As a result, no charge will accumulate in these pixels, so the readout voltage will simply be the reset voltage applied to the pixel (described earlier with reference to FIG. 4), or some other reference voltage that is applied to the capacitance on sides A and B of the pixel as an alternative to the reset voltage. In this case, the accumulation value on pixel may be referred to as a dark/black/zero value since it represents the charge accumulated when no light is incident on the pixel.

In an alternative to the above, rather than applying Ref₁ to one pixel and Ref₂ to a different pixel in the same column, they may be consecutively applied to the same pixel. For example, Ref₁ may be applied at a first time to both sides of a pixel and the pair of single ended signals A₁ and B, readout. Ref₂ may then be applied at a second time to both sides of the pixel and the pair of single ended signals A₂ and B₂ readout.

The skilled person will readily appreciate how to apply reference values to pixels so that the value that is read off the pixel is the applied reference value, for example by applying a reference voltage to the capacitance on sides A and B of the pixel (for example, using the Vrst signal line) and/or by shuffling a known charge into the capacitance on sides A and B of the pixel.

In a further alternative, one or more rows of the image sensor 120 may be made up of blanked/blocked pixels, which are described above. Offset correction may be performed using these pixels. In particular, no charge will accumulate in these pixels, so the readout voltage will simply be the reset voltage applied to the pixel (described earlier with reference to FIG. 4). A difference between the converted readout voltages for sides A and B for such a pixel will be indicative of the offset between the readout circuitry on sides A and B for that column, since the voltage readout for each side A and B should be the reset voltage, or 0, so any difference between single ended signal A and single ended signal B should indicate the amount of offset between the two sides. Therefore, by reading out a pair of single ended signals from a blanked/blocked pixel, offset for a column may be determined from a single readout step and then corrected (either digitally or in analog) for the charge samples readout from other non-blanked/blocked pixels in the same column (for example, corrected in the digital or analogue domain), such that the accuracy of depth and/or 2D IR frames determined using those non-blanked/blocked pixels may be improved.

Optionally, each readout of the image sensor 120 may include reading out the blanked/blocked row(s) of pixels. Those readings may be averaged or low pass filtered over time in order to determine the gain error and/or offset.

Where two or more rows of blanked pixels are included in the image sensor 120, two or more rows of the blanked pixels may be readout out and an interim average of the voltage readout for each column readout line may be determined. The gain error and/or offset for a column may then be determined from comparing the average voltage on side A against the average voltage on side B for that column, either from one single readout, or from multiple readouts over time by performing an average or low pass filtering over time.

2D HDR Mode

In the 2D High Dynamic Range (HDR) mode, a 2D IR frame may be determined from a single readout of the image sensor 420. This mode of operation is applicable both to ToF camera systems and also to non-ToF camera systems, for example camera systems configured simply to generate a 2D image of a scene (and therefore may not include a light source).

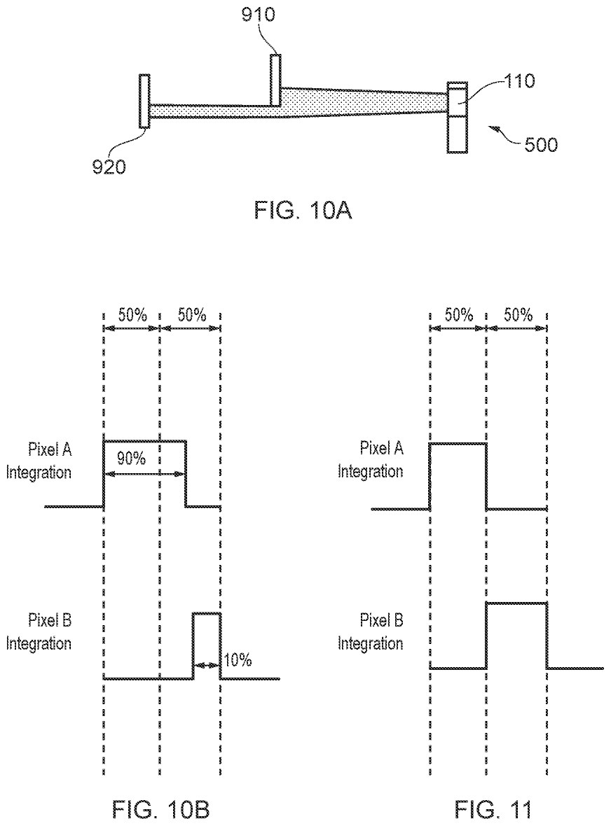

FIG. 10A shows a representation of dynamic range challenges that may be faced by the camera system 500. In particular, in this example, light (which is from any source, not necessarily the camera system 500) is reflected off a highly reflective object 910 at close distance to the camera system 500 and a low reflectivity object 920 at far distance to the camera system 500. A large amount of light may be reflected off object 910, resulting in a large amount of charge accumulation in the pixels 422 on which that reflected light falls. A small amount of light may be reflected off object 920, resulting in a small amount of charge accumulation in the pixels 422 on which that reflected light falls. Thus, the camera system 500 may need to deal with a large dynamic range. The pixels 422 have a full well capacity for accumulating photon energy. Low reflectivity and/or distant objects may cause pixels 422 to accumulate very little charge. However, highly reflective and/or nearby objects may cause the full well capacity of a pixel 422 to be saturated.

In the 2D HDR mode of the present disclosure, the image sensor 420 may be controlled to accumulate charge (‘open the shutter on’) on side A of the pixel 422 for a first amount of time and accumulate charge (‘open the shutter on’) on side B of the pixel 422 for a second amount of time, where the first amount of time is longer than the second amount of time.

FIG. 10B shows an example representation of this, where pixel A is controlled to accumulate (integrate) charge for a first amount of time (in this example, 90% of the overall pixel accumulation time) and pixel B is controlled to accumulate (integrate) charge for a second amount of time (in this example, 10% of the overall pixel accumulation time). Thus, there is effectively a 9:1 ratio of accumulation/exposure for side A vs side B. As a result, side A may be very sensitive to reflected light, since it accumulates received light for longer, and side B may be less sensitive. Whilst this example is described in the context of side A accumulating charge first and then side B, in the alternative side B could be controlled to accumulate charge for the second amount of time, followed by side A for the first amount of time.

As a result, if a particular imaging pixel is imaging an object 910 that is bright enough to saturate side A (i.e., the accumulated charge reaches the maximum signal that can be readout from side A−in other words accumulation reaches full scale), side B will only have accumulated a fraction of the charge ( 1/9^{th} in this example). As a result, if side A saturates, side B can still be used to image the object. On the other hand, if the particular imaging pixel is imaging an object 920 that is relatively dull so side A does not saturate, side A can be used to image the object with greater resolution/accuracy, since it has had longer to accumulate charge.

As such, after reading out the two single ended signals from a pixel 422, the image acquisition system 525 may be configured to determine whether or not the side A signal is saturated, for example may comparing it to a threshold value at or over which side A is considered to be saturated. If the side A signal is determined not to be saturated, that signal may be used for the 2D IR image. If the side A signal is determined to be saturated, then a normalised version of the side B signal may be used for the 2D IR image. The normalised version is a multiple of the side B signal, based on the ratio of side A and side B accumulation time. Therefore, in this example where the side A: side B ratio is 9:1, the normalised version is 9× side B signal.

This may be repeated across all imaging pixels readout from the imaging sensor 420 such that an HDR 2D IR image may be determined using the side A signal or the normalised side B signal for each pixel. As a result of this process, the dynamic range of the camera system 500 may be increased for 2D IR imaging. In this example, where the ratio of side A and side B accumulation time is 9:1, the dynamic range is increased by 9 times.

Optionally, for at least some imaging pixels a weighted combination of the side A signal and normalised side B signal may be used for the 2D IR image. Both the side A and side B signal are subject to photon shot noise, which is proportional to the square root (sqrt) of the signal and to the readout noise. Since the side B signal is less than side A (by 9x in this example), when the side A signal is just below saturation it will have a better signal to noise ratio (SNR) than the side B signal by approximately sqrt(9). Furthermore, if the side B signal is less than the (readout noise)², the SNR of side B becomes even worse relative to side A, converging towards 9 times worse. The consequence of this is that if one pixel is close to, but below, side A saturation and the side A signal is used in the 2D IR image for that pixel, but a nearby pixel is at or above side A saturation and the normalised side B signal is used in the 2D IR image for that pixel, there may be a sudden jump in noise in the 2D IR image, which may be undesirable. Therefore, a weighted combination of the side A and normalised side B signal may be used to smooth any noise transition, for example:

Pixel value=xA+yB′

where
B′=the normalised side B signal
x=weighting factor applied to the side A signal
y=weighting factor applied to the side B signal

The values used for x and y may vary and may be determined, for example, using a look up table or a formula, based on the size of the side A signal and/or side B signal. For example, if the side A signal is comfortably below the saturation level, such as less than 90% or less than 80%, etc of the saturation level, x may be set to 1 and y may be set to 0. However, as the side A signal approaches saturation, the values may change such that the pixel value used in the 2D IR image is increasingly made up of the normalised side B signal. For example, when the side A signal is at 90% of saturation, x may be set to 0.9 and y may be set to 0.1. As the side A signal increases towards saturation those values may change (either linearly or in any other suitable way), so that when the side A signal is at, say, 99% saturation, x is set to 0.1 and y is set to 0.9. When 100% saturation is reached on side A, x may be set to 0 and y may be set to 1.

The consequence of this is that as side A nears saturation and the pixel value is increasingly made up of the normalised side B signal, the pixel value will have an increasingly worse SNR, but abrupt/obvious changes in SNR in the 2D IR image may be avoided.

Optionally, the values of x and y may be set based not only on proximity to saturation, but also based on the nature of the scene being imaged and/or based on user settings applied to the camera system 500. As a result, a plurality of different formulas and/or look up tables may be used for determining the values of x and y depending on the scene being imaged and/or the user settings.

In the example described above, there is an accumulation ratio of 9:1 between side A and side B. However, any other suitable accumulation ratio may be used, where a larger ratio may result in a higher dynamic range, but worse SNR on the side B signal. Furthermore, in the above example it is the image acquisition system 525 that determines the 2D IR image. However, in an alternative it may output the side A and B signals for each readout pixel to the processor 540 for the determination of a 2D IR image.

Low Noise 2D Mode

In the low noise 2D mode, a 2D IR frame may be determined from a single readout of the image sensor 420. This mode of operation is applicable both to ToF camera systems and also to non-ToF camera systems, for example camera systems configured simply to generate a 2D image of a scene (and therefore may not include a light source).

The image acquisition system 525 may be configured to control side A and side B of the pixels to accumulate at a ratio of 50:50 (i.e., the amount of time for which accumulation takes place on side A is the same as for side B). FIG. 11 shows an example representation of this.

In this mode of operation, side A and side B are effectively measuring the same 2D IR image and the full well capacity of both sides may be utilised. During the readout period following the accumulation period, the two single ended signals may be readout from each pixel 422 and for each pixel 422 measurements A and B may be digitally averaged. A 2D IR frame may then be determined using the average of A and B (i.e., based on the magnitude of the average of A and B) for each readout pixel. By doing this, a √2 improvement in SNR may be achieved, thereby reducing noise in the 2D IR frame.

High Speed 2D Mode

This mode of operation is applicable both to ToF camera systems and also to non-ToF camera systems, for example camera systems configured simply to generate a 2D image of a scene (and therefore may not include a light source).

The image acquisition system 525 may be configured to control side A and side B of the pixels to accumulate charge mostly, or entirely, on side A. Side B of each pixel 422 may effectively be disabled or ignored. For example, in a ToF camera system side A may be controlled to accumulate charge for 99% of the overall pixel accumulation time and side B may be controlled to accumulate charge for the remaining 1% of the overall pixel accumulation time.

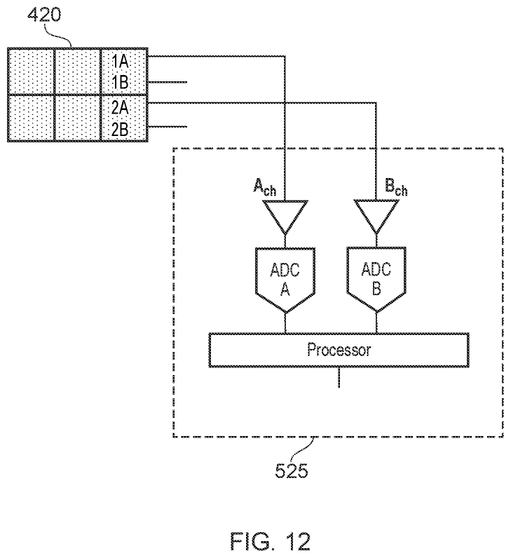

With reference to FIG. 5, it can be seen that the image acquisition system 525 may be configured to have an A side ADC (and optionally also an A side amplifier) for each pixel 422 in a row (i.e., m A side ADCs) and a B side ADC (and optionally also a B side amplifier) for each pixel 422 in a row (i.e., m B side ADCs). However, in this mode of operation, the B side of the pixels 422 is not being used. Therefore, the B side ADCs (and corresponding amplifiers) may instead be used to readout the A side charges for another row in the image sensor 420. For example, the A side of the pixels 422 in row N may be readout by the A side ADCs, and the A side of the pixels 422 in row N+1 may be simultaneously readout by the B side ADCs. Thus, the A side ADCs may be used for reading out the A side of pixels 422 in rows N, N+2, N+4, etc, and the B side ADCs may be used for reading out the A side of pixels 422 in rows N+1, N+3, N+5, etc. FIG. 12 shows an example visualisation of this mode of operation. The system may be reconfigurable to switch between this high speed 2D mode of operation and a mode of operation that makes use of the B side readings in any suitable way. For example, for half of the pixel rows, the A side of each pixel may be switchably coupled to both the A and B side ADCs (and optionally also amplifiers when amplifiers are used). The B side of each pixel for all rows may also be switchably coupled to the B side ADCs (and optionally also amplifiers when amplifiers are used). As such, when both A and B side signals are to be used, the switches may be set such that the A side readout line for each column is coupled to its respective A side ADC, and the B side readout line for each column is columned to its respective B side ADC. When high speed 2D mode is desired, the switching may change so that for half of the pixel rows, the A side readout line for each column is coupled to its respective A side ADC, and for the other half of the pixel rows the A side readout line for each column is coupled to its respective B side ADC.

For all of the different modes of operation above, some even further benefits may be realised by additional operations of the image acquisition system 525.

Each of the different 2D IR modes of operation described above may be used to generate a 2D IR image of a scene, either by a ToF camera system or any other type of camera system. In the case of a ToF camera system, it may optionally be configured to determine a 3D/depth frame using a CW or pulsed mode of operation, as described above, followed by a 2D IR frame where the light source 110 is not used at all such that the 2D IR image captures an image of the background light.

Compression

For example, data compression may be implemented to reduce the amount of data that needs transmitting and processing. For example, image acquisition system 525 may determine the value A−B for each pixel 422 and then output A−B for each pixel 422 to an application processor via a data bus for processing into a depth frame and/or 2D IR frame. As will be appreciated, this may represent a significant amount of data for transmission and onward processing for each frame, which may increase both time and power consumption for generating a depth frame and/or 2D IR frame.

Optionally, the image acquisition system 525 may apply compression to the A−B value before onward transmission. The image acquisition system 525 may first determine whether or not a difference value A−B is suitable for compression and, by virtue of having read A and B off each pixel as two single ended signals, there are various ways in which this may be done. For example, determining whether or not A−B can be compressed may be based on any one or more of:
comparing A−B to a predetermined size threshold and, if it is less than the size threshold, then A−B can be compressed. In particular, if A−B is small, it may be assumed that a relatively large amount of the value is noise. In this case, adding further to the noise by compressing the signal may be acceptable since noise is already such a significant factor. The size threshold may be set to any amount below which noise is considered to be a relatively significant part of the signal, for example. if A−B can be up to a 16-bit value, the size threshold may be set to 2³, or 2⁴ or 2⁵ etc depending on the system.
identifying a region of imaging pixels where A+B is similar to within a similarity threshold. For example, a group of adjacent pixels may be identified where the spread of A+B between each imaging pixel within the group does not exceed the similarity threshold. In this example, adjacent pixels may be physically directly adjacent to each other within the imaging sensor (for example, imaging pixels located in the very next pixel column and/or row), or if only some imaging pixels are readout from the imaging sensor (for example, a non-contiguous selection of imaging pixels are readout from locations spread across the imaging sensor) then “adjacent pixels” are neighbouring pixels within the set of imaging pixels that have been readout. By identifying a region of imaging pixels where A+B is within a similar threshold, a “flat” region imaging essentially the same thing has been found. As such, the value A−B from those imaging pixels may be compressed since the resultant reduction in resolution will be acceptable. The size of the similarity threshold may be set to any suitable value depending on the application of the camera system and the degree of accuracy/resolution of imaging required.

In one example implementation, a single compression scheme may be used, such that if it should be determined that A−B can be compressed, that compression scheme is used. In this case, the pixel data may comprise a single bit compression flag set to indicate whether or not compression has taken place. In another example implementation, a plurality of different compression schemes may be used. In this case, the extent to which compression may take place may be determined using the technique above (for example, by considering the extent to which A−B is less than the size threshold, or how closely similar the A+B value of a group of pixels is, or determining whether a group of imaging pixels that have similar A+B values also have A−B values less than the size threshold, etc). Where possible, for example because A−B is very small or because A+B for a group of pixels is very similar, a more significant compression may be applied. As such, the compression flag may be a multibit code configured to indicate which compression scheme has been used.

The drawing below shows example pixel data for an imaging pixel. In this case, the compression flag is a single bit flag. The sign indicates whether A−B is a positive or negative value.

When the pixel data is received by the application processor, it may use the compression flag to determine whether or not compression has taken place (and optionally what type of compression was used) and decompress the difference value A−B if necessary before generating the image frame. Thus, a reduced amount of data may be transmitted, which may be particularly beneficial for the 3D modes of operation described above, where A−B is utilised extensively.

Confidence

Additionally or alternatively, pixel data for each imaging pixel may include a confidence indicator. The values read out from the image sensor 420 may be sensitive to the environment being imaged, particularly for scenes where objects close to the image sensor 420 can saturate pixels 422 and where objects far away from the image sensor 420 can return low signal strength (as explained previously).

For objects that are far away from the image sensor 420, noise such as photon shot noise or readout noise may be a significant component in the readout data, such that the readout data is no longer very reliable. However, it is not possible to tell this from A−B because a very small value for A−B may be caused by two very reliable, large values for A and B that happen to be very similar to each other, or may be caused by two very small values for A and B, which may not be very reliable. By reading A and B out as separate single ended signals, it is possible to determine confidence in A−B by looking at the size of A, B and/or A+B. If A and B are both below a first threshold value (for example, a threshold value that is close to the “black” or “zero” value of the pixel), and/or if A+B is below a second threshold value, it may be assumed that the signal strength is very low, such that noise in the readout data is significant. In this case, a confidence indicator accompanying the determined value A−B in the pixel data may be set to indicate a low confidence in the reliability of the value A−B. In some implementations, the confidence indicator may be a single bit value indicating simply “confident” or “not confident”. In other implementations, the values of A, B and/or A+B may be compared to a plurality of thresholds such that the degree of confidence may be indicated by a multi-bit confidence indicator. The thresholds may be set to any suitable value depending of the requirements and application of the camera system.

Where objects are very close to the image sensor 420 and the sensor saturates, again the value of A−B may not be very reliable because the value may no longer be indicative of the true distance to the image sensor 420. In this case, the value of A and/or B may be compared against a particular threshold value (for example, a value at or close to the pixel saturation level). If A or B is equal to (or within a predetermined distance of) the saturation level, it may be assumed that they have saturated. In this case, a confidence indicator accompanying the determined value A−B may be set to indicate a low confidence in the reliability of the value A−B. Again, optionally the comparison may be against a plurality of thresholds such that the confidence indicator may indicate the degree of confidence in A−B.

Additionally, or alternatively, A, B and/or A+B for one pixel may be compared against A, B and/or A+B for one or more adjacent pixels that have been readout from the imaging sensor. The larger the difference between the values of A, B and/or A+B for two adjacent pixels, the less confidence there may be. Typically, it would be expected that changes in A, B and/or A+B between adjacent imaging pixels would be relatively small as transitions tend to be quite gradual at the scale of individual imaging pixels. Therefore, a very large difference between two adjacent imaging pixels may suggest there is a problem with the values readout from one or both imaging pixels (for example, a failure in an imaging pixel and/or part of the readout circuitry). By comparing, for all imaging pixels across the imaging sensor, the readout values of adjacent imaging pixels, it is possible to pinpoint individual imaging pixels whose readout values may not be reliable and set the confidence indicator accompanying A−B accordingly.

It should be appreciated that the above described techniques may identify unreliable signals that would not be apparent by looking at A−B, since problems with the values A and/or B would likely be disguised by subtracting the two. Therefore, reading out A and B as two single ended signals may be beneficial for enhancing the confidence with which the value A−B may be used. Additionally or alternatively it may also act as a safety feature where the camera system is used in a safety critical environment, since low confidence in one or more values readout from an imaging sensor may flag a safety problems with the system.

The confidence indicator may take any suitable form, for example a single bit indicating ‘high’ or ‘low’ confidence, or a multi-bit word indicating level of confidence, or indicating in which of the comparisons above confidence has been determined. For example, there may be one bit to indicate whether or not A+B<predetermined threshold, another bit to indicate whether or not A<saturation level, etc. In one example where the value of A−B is a 12-bit value, the confidence indicator may be a 4-bit value such as:

This 16-bit word may then be transmitted from the image acquisition system 525 to an application processor for additional processing to generate a depth frame and/or 2D IR frame. Confidence in the quality of the measurement A−B may be valuable during that additional processing, for example so that unreliable values of A−B may be ignored when determining the depth frame and/or 2D IR frame. Consequently, a more accurate and reliable depth frame and/or 2D IR frame may be determined.

In an alternative, confidence may be determined in any other value that may be determined according to the modes of operation described above, for example A, B, A+B, etc. The determination may be performed by any suitable entity, such as the image acquisition system 525, or the application processor, etc.

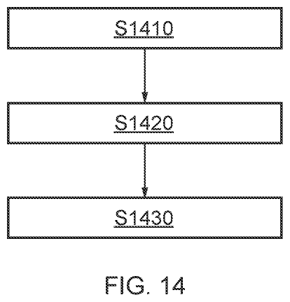

FIG. 14 shows the example steps of a process performed by the camera system of the present disclosure. The camera system may be a ToF camera system, or in the case of any of the 2D IR modes of operation described above, it may be any other suitable type of camera system, which may be similar in design to the ToF camera system 500, but lack the laser light source 110.

In Step S1410, the image acquisition system 525 controls the charge accumulation timing of the image sensor 420 in any of the ways described above.

In Step S1420, the image acquisition system 525 reads out from each of a plurality of the differential imaging pixels a pair of single ended signals.

In Step S1430, the camera system 525 processes the readout signals to determine an image, for example a depth frame and/or a 2D IR frame, in any of the ways described above. This processing may be performed by the image acquisition system 525 and/or the processor 540, for example the image acquisition system 525 performing some processing (such as compression and/or confidence determination, etc) on the readout signals before forwarding them to the processor 540 for determination of the image.

The aspects of the present disclosure described in all of the above may be implemented by software, hardware or a combination of software and hardware. For example, processing of the readout signals by the image acquisition system 525 and/or processor 540 may be carried out according to software comprising computer readable code, which when executed on one or more processors (such as the memory processor and controller 140 and/or the processor 540), performs the processes described above. The software may be stored on any suitable computer readable medium, for example a non-transitory computer-readable medium, such as read-only memory, random access memory, CD-ROMs, DVDs, Blue-rays, magnetic tape, hard disk drives, solid state drives and optical drives.

Throughout this disclosure, the term “electrically coupled” or “electrically coupling” encompasses both a direct electrical connection between components, or an indirect electrical connection (for example, where the two components are electrically connected via at least one further component).

The skilled person will readily appreciate that various alterations or modifications may be made to the above described aspects of the disclosure without departing from the scope of the disclosure.

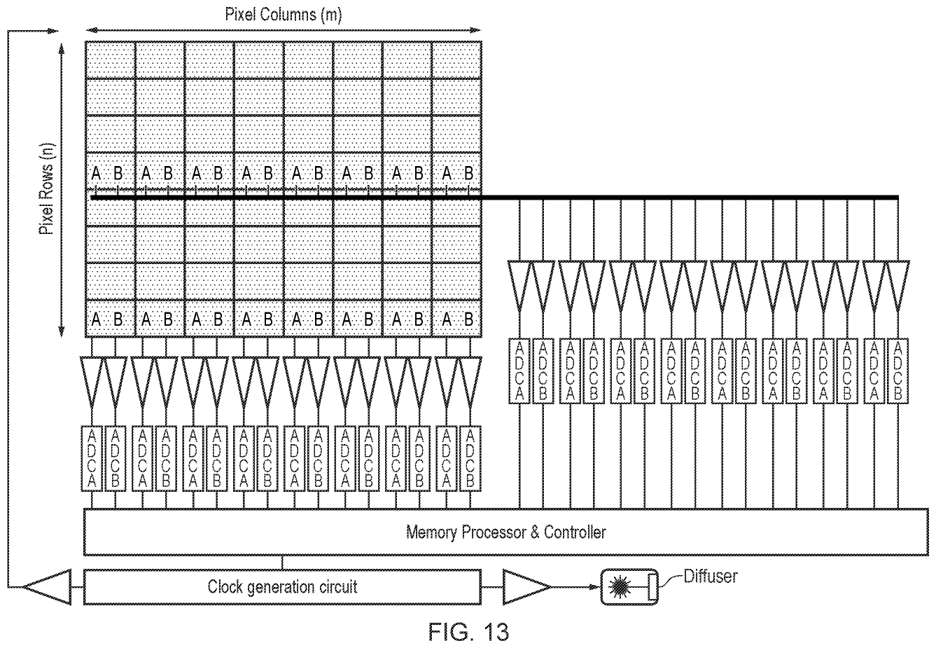

For example, the image acquisition system 525 may be configured to have more than one pair of ADCs (and optional corresponding amplifiers) per column of the image sensor 420. For example, FIG. 13 shows a representation where a second pair are provided for each column, such that two rows may be readout from the image sensor 420 at once. As a result, the readout time may be reduced by reading two or more rows at a time. Whilst this would increase the number of ADCs required for the image acquisition system 525, because they may all be smaller than the ADCs required to convert a differential signal (i.e., they may convert to a fewer number of bits), it may be possible to include those additional single ended ADCs within the image acquisition system 525.

The image sensor 420 described above is a CMOS image sensor. However, any other suitable form of differential pixel image sensor may alternatively be used.

In the above, the camera system 500 includes a laser light source. However, it may alternatively be any other suitable type of light source, such as an LED.

### Select Examples

Example 1 provides a time of flight (ToF) camera system comprising: an image sensor comprising a plurality of differential imaging pixels; and an image acquisition system coupled to the image sensor and configured to: readout one or more of the imaging pixels by reading out two single ended signals from each of the one or more imaging pixels.

Example 2 provides a system according to one or more of the preceding and/or following examples, further comprising: a light source, wherein the image acquisition system is configured to operate the light source and the image sensor in a continuous wave and/or pulsed mode of operation.

Example 3 provides a system according to one or more of the preceding and/or following examples, wherein the image sensor is a CMOS image sensor.

Example 4 provides a system according to one or more of the preceding and/or following examples, wherein the image acquisition system is configured to: digitally convert the two single ended signals readout from an imaging pixel; and determine a difference between the two digitally converted single ended signals.

Example 5 provides a camera system comprising an image sensor comprising a plurality of differential imaging pixels; and an image acquisition system coupled to the image sensor and configured to: readout the plurality of imaging pixels by reading out a first single ended signal and a second single ended signal from each of the one or more imaging pixels; for each of at least some of the one or more imaging pixels, determine pixel data based on the first single ended signal and the second single ended signal, wherein the pixel data comprises a difference value indicative of a difference between a first single ended signal and the second single ended signal; and output the pixel data to a processor for the determination of a ToF image frame

Example 6 provides a system according to one or more of the preceding and/or following examples, wherein the pixel data comprises: a confidence value indicative of a relative confidence in the difference value.

Example 7 provides a system according to one or more of the preceding and/or following examples, wherein the confidence value is determined by at least one of the following: comparing the first single ended signal against a first predetermined confidence threshold; comparing the second single ended signal against a second predetermined confidence threshold; comparing a sum of the first and second single ended signals against a third predetermined confidence threshold; comparing the first single ended signal against a first single ended signal readout from an adjacent imaging pixel; comparing the second single ended signal against a second single ended signal readout from an adjacent imaging pixel; comparing the sum of the first and second single ended signals against a sum of first and second single ended signals readout from an adjacent imaging pixel.

Example 8 provides a system according to one or more of the preceding and/or following examples, wherein the first predetermined confidence threshold comprises one or more of: a saturation level of the imaging pixels; and a dark level of the imaging pixels; and wherein the second predetermined confidence threshold comprises one or more of: the saturation level of the imaging pixels; and the dark level of the imaging pixels.

Example 9 provides a system according to one or more of the preceding and/or following examples, wherein comparing the first single ended signal against the first single ended signal readout from the adjacent imaging pixel comprises: determining a difference between the between the first single ended signal against the first single ended signal readout from the adjacent imaging pixel; and comparing the determined difference to a fourth predetermined confidence threshold, wherein if the determined difference is greater than the fourth predetermined confidence threshold, the confidence value is set to indicate a relatively low level of confidence.

Example 10 provides a system according to one or more of the preceding and/or following examples, wherein the pixel data comprises a compression flag, and wherein determining the pixel data comprises: determining whether the difference between the first single ended signal and the second single ended signal can be compressed, and if it can be compressed, setting the difference value as a compressed version of the difference between the first single ended signal and the second single ended signal; and setting the compression flag to indicate whether or not the difference value is a compressed value.

Example 11 provides a system according to one or more of the preceding and/or following examples, wherein determining whether the difference between the first single ended signal and the second single ended signal can be compressed comprises one or more of the following: comparing the difference between the first single ended signal and the second single ended signal to a predetermined size threshold, wherein if it is less than the predetermined size threshold it can be compressed; identifying a region of the imaging sensor where a sum of the first single ended signal and the second single ended signal readout from each imaging pixel within the region is similar to within a similarity threshold, the difference between the first single ended signal and the second single ended signal readout from the imaging pixels within the region can be compressed.

Example 12 provides a system according to one or more of the preceding and/or following examples, wherein the processor is configured to determine a ToF image based on the pixel data received from the image acquisition system.

Example 13 provides a system according to one or more of the preceding and/or following examples, wherein the ToF camera system is a continuous wave ToF camera system.

Example 14 provides a system according to one or more of the preceding and/or following examples, wherein the image acquisition system comprises first readout circuitry for reading out the first single ended signal and second readout circuitry for reading out the second single ended signal.

Example 15 provides a system according to one or more of the preceding and/or following examples, wherein the image acquisition system comprises first readout circuitry for reading out the first single ended signal and second readout circuitry for reading out the second single ended signal.

Example 16 provides a system according to one or more of the preceding and/or following examples, further configured to correct an offset between the first single ended signal and the second single ended signal caused by mismatch of the first readout circuitry and the second readout circuitry.

Example 17 provides a system according to one or more of the preceding and/or following examples, wherein the image sensor comprises at least one row of blank pixels configured such that incident light on the image sensor does not result in charge accumulation in the blank pixels, and wherein correcting the offset between the first single ended signal and the second single ended signal for a particular imaging pixel comprises: determining a difference between a first single ended signal of a blank pixel that is in the same pixel column as the particular imaging pixel and a second single ended signal of the blank pixel that is in the same pixel column as the particular imaging pixel; and correcting the offset between the first single ended signal and the second single ended signal for the particular imaging pixel using the determined difference.

Example 18 provides a system according to one or more of the preceding and/or following examples, further configured to correct an offset and gain error between the first single ended signal and the second single ended signal caused by mismatch of the first readout circuitry and the second readout circuitry, wherein correcting the offset between the first single ended signal and the second single ended signal for a particular imaging pixel comprises: reading out a first pair of single ended signals from a first pixel that is in the same pixel column as the particular imaging pixel, wherein the accumulation values at the first pixel are a first known value; reading out a second pair of single ended signals from a second pixel that is in the same pixel column as the particular imaging pixel, wherein the accumulation values at the second pixel are a second known value; and determining the offset and gain error based on the first pair of single ended signals and the second pair of single ended signals.

Example 19 provides a system according to one or more of the preceding and/or following examples, wherein the first known value is a first reference value applied to the first pixel, and wherein the second known value is a second reference value applied to the second pixel.

Example 20 provides a system according to one or more of the preceding and/or following examples, wherein the first known value is a first reference value applied to the first pixel, and wherein the second pixel is blank pixel configured such that incident light on the image sensor does not result in charge accumulation in the second pixel.

Example 21 provides a method for determining a ToF image frame, the method comprising: an image sensor comprising a plurality of differential imaging pixels; and an image acquisition system coupled to the image sensor and configured to: reading out charge from a plurality of differential imaging pixels of an image sensor, wherein the charge from each differential imaging pixel is readout as a first single ended signal from a first side of the differential imaging pixel and a second single ended signal from a second side of the differential imaging pixel; determining, for each of the plurality of imaging pixels, a difference between the first single ended signal and the second single ended signal; and determining the ToF image frame using the determined difference between the first single ended signal and the second single ended signal for the plurality of imaging pixels.

Example 22 provides a camera system comprising an image sensor for receiving light reflected by an objected being imaged, wherein the image sensor comprises a plurality of differential imaging pixels; and an image acquisition system coupled to the imaging sensor and configured to: control charge accumulation timing of the plurality of differential imaging pixels such that a first side of the imaging pixels accumulates charge for a first period of time and a second side of the imaging pixels accumulates charge for a second period of time, wherein the first period of time is longer than the second period of time; and readout from each of the plurality of differential pixels a first single ended signal indicative of a charge accumulated by the first side of the imaging pixel and a second single ended signal indicative of a charge accumulated by the second side of the imaging pixel.

Example 23 provides a camera system according to one or more of the preceding and/or following examples, further configured to determine an image using the signals readout from the imaging sensor, wherein determining the image comprises: for each of the plurality of differential pixels, determining from the first single ended signal whether or not the first side of the imaging pixel is saturated, and if the first side of the imaging pixel is determined not to be saturated, use the first single ended signal for the determination of the image, otherwise if the first side of the imaging pixel is determined to be saturated, use the second single ended signal for the determination of the image.

Example 24 provides a camera system according to one or more of the preceding and/or following examples, wherein determining whether or not the first side of the imaging pixel is saturated comprises comparing the first single ended signal to a saturation threshold.

Example 25 provides a camera system according to one or more of the preceding and/or following examples, further configured to determine an image using for each pixel of the image a weighted combination of the first single ended signal and the second single ended signal, wherein the system is further configured to determine a size of weighting applied to the first single ended signal and a size of the weighting applied to the second single ended signal based on how close the first single ended signal is to saturation.

Variations and Implementations

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The preceding disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the description and the claims. Note that all optional features of the apparatus described above may also be implemented with respect to the method or process described herein and specifics in the examples may be used anywhere in one or more embodiments.

The ‘means for’ in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

What is claimed is:

1. A time of flight, ToF, camera system comprising:
an image sensor comprising a plurality of differential imaging pixels; and
an image acquisition system coupled to the image sensor and configured to:
readout the plurality of imaging pixels by reading out a first single ended signal and a second single ended signal from each of the one or more imaging pixels;
for each of at least some of the one or more imaging pixels, determine pixel data based on the first single ended signal and the second single ended signal, wherein the pixel data comprises a difference value indicative of a difference between a first single ended signal and the second single ended signal; and
output the pixel data to a processor for the determination of a ToF image frame.

2. The time of flight, ToF, camera system of claim 1, wherein the pixel data comprises:
a confidence value indicative of a relative confidence in the difference value.

3. The time of flight, ToF, camera system of claim 2, wherein the confidence value is determined by at least one of the following:
comparing the first single ended signal against a first predetermined confidence threshold;
comparing the second single ended signal against a second predetermined confidence threshold;
comparing a sum of the first and second single ended signals against a third predetermined confidence threshold;
comparing the first single ended signal against a first single ended signal readout from an adjacent imaging pixel;
comparing the second single ended signal against a second single ended signal readout from an adjacent imaging pixel;
comparing the sum of the first and second single ended signals against a sum of first and second single ended signals readout from an adjacent imaging pixel.

4. The time of flight, ToF, camera system of claim 3, wherein the first predetermined confidence threshold comprises one or more of: a saturation level of the imaging pixels; and a dark level of the imaging pixels; and
wherein the second predetermined confidence threshold comprises one or more of: the saturation level of the imaging pixels; and the dark level of the imaging pixels.

5. The time of flight, ToF, camera system of claim 5, wherein comparing the first single ended signal against the first single ended signal readout from the adjacent imaging pixel comprises:
determining a difference between the between the first single ended signal against the first single ended signal readout from the adjacent imaging pixel; and
comparing the determined difference to a fourth predetermined confidence threshold, wherein if the determined difference is greater than the fourth predetermined confidence threshold, the confidence value is set to indicate a relatively low level of confidence.

6. The time of flight, ToF, camera system of claim 1, wherein the pixel data comprises a compression flag, and wherein determining the pixel data comprises:
determining whether the difference between the first single ended signal and the second single ended signal can be compressed, and if it can be compressed, setting the difference value as a compressed version of the difference between the first single ended signal and the second single ended signal; and
setting the compression flag to indicate whether or not the difference value is a compressed value.

7. The time of flight, ToF, camera system of claim 6, wherein determining whether the difference between the first single ended signal and the second single ended signal can be compressed comprises one or more of the following:
comparing the difference between the first single ended signal and the second single ended signal to a predetermined size threshold, wherein if it is less than the predetermined size threshold it can be compressed;
identifying a region of the imaging sensor where a sum of the first single ended signal and the second single ended signal readout from each imaging pixel within the region is similar to within a similarity threshold, the difference between the first single ended signal and the second single ended signal readout from the imaging pixels within the region can be compressed.

8. The time of flight, ToF, camera system of claim 1, wherein the processor is configured to determine a ToF image based on the pixel data received from the image acquisition system.

9. The time of flight, ToF, camera system of claim 1, wherein the ToF camera system is a continuous wave ToF camera system.

10. The time of flight, ToF, camera system of claim 1, wherein the image acquisition system comprises first readout circuitry for reading out the first single ended signal and second readout circuitry for reading out the second single ended signal.

11. The time of flight, ToF, camera system of claim 10, further configured to correct an offset between the first single ended signal and the second single ended signal caused by mismatch of the first readout circuitry and the second readout circuitry.

12. The time of flight, ToF, camera system of claim 11 wherein the image sensor comprises at least one row of blank pixels configured such that incident light on the image sensor does not result in charge accumulation in the blank pixels, and wherein correcting the offset between the first single ended signal and the second single ended signal for a particular imaging pixel comprises:
determining a difference between a first single ended signal of a blank pixel that is in the same pixel column as the particular imaging pixel and a second single ended signal of the blank pixel that is in the same pixel column as the particular imaging pixel; and
correcting the offset between the first single ended signal and the second single ended signal for the particular imaging pixel using the determined difference.

13. The time of flight, ToF, camera system of claim 10, further configured to correct an offset and gain error between the first single ended signal and the second single ended signal caused by mismatch of the first readout circuitry and the second readout circuitry, wherein correcting the offset between the first single ended signal and the second single ended signal for a particular imaging pixel comprises:
reading out a first pair of single ended signals from a first pixel that is in the same pixel column as the particular imaging pixel, wherein the accumulation values at the first pixel are a first known value;
reading out a second pair of single ended signals from a second pixel that is in the same pixel column as the particular imaging pixel, wherein the accumulation values at the second pixel are a second known value; and
determining the offset and gain error based on the first pair of single ended signals and the second pair of single ended signals.

14. The time of flight, ToF, camera system of claim 13, wherein the first known value is a first reference value applied to the first pixel, and wherein the second known value is a second reference value applied to the second pixel.

15. The time of flight, ToF, camera system of claim 13, wherein the first known value is a first reference value applied to the first pixel, and wherein the second pixel is blank pixel configured such that incident light on the image sensor does not result in charge accumulation in the second pixel.

16. A method for determining a ToF image frame, the method comprising:
an image sensor comprising a plurality of differential imaging pixels; and
an image acquisition system coupled to the image sensor and configured to:
reading out charge from a plurality of differential imaging pixels of an image sensor, wherein the charge from each differential imaging pixel is readout as a first single ended signal from a first side of the differential imaging pixel and a second single ended signal from a second side of the differential imaging pixel;
determining, for each of the plurality of imaging pixels, a difference between the first single ended signal and the second single ended signal; and
determining the ToF image frame using the determined difference between the first single ended signal and the second single ended signal for the plurality of imaging pixels.

17. A camera system comprising:
an image sensor for receiving light reflected by an objected being imaged, wherein the image sensor comprises a plurality of differential imaging pixels; and
an image acquisition system coupled to the imaging sensor and configured to:
control charge accumulation timing of the plurality of differential imaging pixels such that a first side of the imaging pixels accumulates charge for a first period of time and a second side of the imaging pixels accumulates charge for a second period of time, wherein the first period of time is longer than the second period of time; and
readout from each of the plurality of differential pixels a first single ended signal indicative of a charge accumulated by the first side of the imaging pixel and a second single ended signal indicative of a charge accumulated by the second side of the imaging pixel.

18. The system of claim 17, further configured to determine an image using the signals readout from the imaging sensor, wherein determining the image comprises:
for each of the plurality of differential pixels, determining from the first single ended signal whether or not the first side of the imaging pixel is saturated, and
if the first side of the imaging pixel is determined not to be saturated, use the first single ended signal for the determination of the image, otherwise
if the first side of the imaging pixel is determined to be saturated, use the second single ended signal for the determination of the image.

19. The system of claim 18, wherein determining whether or not the first side of the imaging pixel is saturated comprises comparing the first single ended signal to a saturation threshold.

20. The system of claim 17, further configured to determine an image using for each pixel of the image a weighted combination of the first single ended signal and the second single ended signal, wherein the system is further configured to determine a size of weighting applied to the first single ended signal and a size of the weighting applied to the second single ended signal based on how close the first single ended signal is to saturation.
